(19) United States
(12) Patent Application Publication
(10) Pub. No.: US 2006/0041499 A1
(43) Pub. Date: Feb. 23, 2006

(54) Obtaining A Need With Guiding Information And Credit Worthiness Using A Competitive Process

(75) Inventor: Nagendra Nagarajayya, Pleasanton, CA (US)

Correspondence Address: Nagendra Nagarajayya, 4302 Denker Dr, Pleasanton, CA, 94588, US

(73) Assignee: TRANSAXTIONS LLC, Pleasanton, CA (US)

(21) Appl. No.: 11/161,897

(22) Filed: Aug. 22, 2005

Related U.S. Application Data
(63) Continuation of application No. 60/603,922, filed on Aug. 23, 2004.

(51) Int. Cl. G06Q 40/00

(52) U.S. Cl. 705/37

(57) ABSTRACT

A process for obtaining a need with guiding information and credit worthiness using a competitive process. The competitive process could be a reverse auction where multiple sellers bid on the need. The guiding information and credit worthiness make the need under bid a competitive one for the buyer and the seller, allowing the buyer to obtain the need at an attractive price, while allowing the seller to sell at a reasonable price.

### FIELD OF THE INVENTION

The present invention relates to a need being made available to a market with guiding information and credit worthiness, enabling the need to be bid upon in a competitive manner.

### BACKGROUND OF THE INVENTION

An auction process is where a plurality of sellers and buyers come together to create a market for selling or buying needs. A need from a buyer perspective is to buy an item while from a seller perspective is to sell an item. An item could be a consumer item like TV, Home Theater System or it could be commodities like coffee beans, tea, food products or utilities and energy or collectibles like art, dolls, coins, etc.

There are many types of auctions like Normal auction, Dutch auction, Reverse auction, and Internet auction.

In a Normal auction or English auction, an item is placed for auction at an auction house by a seller. The auction house invites buyers to bid on the item. The start bid is usually low and increases with every bid by a buyer. The last bidder wins and buys the item. The seller gets to sell an item to a plurality of buyers and gets a good price for the item. Sometimes the seller sets a reserve price for the auction. If the reserve price is not met during bidding the item is not auctioned.

In a Dutch Auction, the auction house sets the start bid price high for an item and lowers the bid price in stages. The Dutch auction is also used to sell item in lots or individually. A buyer can bid at any time during the auction process and buy the entire lot or individually. The Dutch auction continues if there are items remaining in the lot, with the auctioneer raising the price to a known price. The bidding starts all over again, and the price could drop below the price paid by the first buyer and the next buyer could buy at a price lower. The Dutch auction also has a reserve price and if the price falls to the reserve price the items are made available to the buyers at the reserve price. If there are no bids at the reserve price the items are passed for auction at another time.

A reverse auction is the reverse of a normal auction. Here a buyer makes available the need for an item and maybe at a price, and sellers now bid on the need, with the bid being lowered with each bid. The lowest priced seller wins to sell the item to the buyer. The buyer could buy if it is above the named price but has to buy if it is below the named price.

An internet auction can be a Normal, Dutch or a Reverse auction. Instead of the auction taking place in an auction house, the auctions take place on the internet called business to consumer (b2c). Buyers and Sellers now make available the need to sell an item or buy an item over the internet. The buyers and sellers could now be spread across the globe to be part of the auction. A seller makes available an item for auction after registering with an internet auction site. The buyers participate in the auction on the internet and can simultaneously bid on an item. If it is a normal auction, the highest bidder wins the auction and not the last bidder. If it is a Dutch or a Reverse auction, the lowest bidder wins the auction.

With the advance of the internet, business exchanges are now coming into prominence. Here a host of buyers and vendors are members of an exchange, and offer products to sell and needs to be purchased. The business to business (b2b) commerce works on matching a buyer and seller so that a transaction can be made successfully. There are 3 types of b2b models, catalog, auction and bid identified by Forrester Research. Catalog involves one buyer and one seller mirroring the traditional relationship enhanced by the internet. The auction model involves an online bidding event where buyers bid for the business from vendors. The vendors control the bid price and bid acceptance. The bid model involves real time bidding from multiple suppliers in order to win a buyer's business. The bid model is the most promising with the most potential going forward.

The normal auction process, reverse auction process including the Dutch auction process all have flaws. In a normal auction, a buyer might pay a lot more when similar products are available in stores. Prof. Richard Freeman, co-director of the “Centre for Economic Performance at the London School of Economics” and Harvard professor, is looking at user behavior at internet auctions. He warns that users get excited and often bid too high called the winner's curse. In Christmas 2000, Sony Playstations were being sold at inflated prices at internet auctions while High Street stores were selling it at reasonable prices. Cautionary tales abound of hapless shoppers unable to control their obsession and caught in bidding wars for items that they did not want. In a New York Times piece, Michelle Slatalla confesses of buying an item for $2300 when she set out to buy a used system for $800. Reverse auctions on the other hand allow the buyer to set a price and bidding to be initiated by the sellers. But a buyer not knowing the market information can set too high a price for a product and buy at above market prices. Sellers might employ collective selling to keep bid prices high. The buyer bidding in a Dutch auction does not know if the bid made is a reasonable bid. A Buyer in an auction might not be very knowledgeable about an item, or if the item is a popular item, or the market information for the item like the low price or average price for a region. They have to do their own research and end up buying items that they might not need or paying a high price for it instead of a reasonable price. Reverse Auctions also introduce deterioration in buyer/seller relationship due to falling prices.

A definite need exists for guiding information that would overcome the problems associated and described above. It would be very helpful if guiding information is available with credit worthiness of the buyer. A primary purpose of the present invention is to solve these needs and provide further, related advantages.

### BRIEF DESCRIPTION OF THE INVENTION

Every presence has needs. A need could be consumer electronics, loans, autos, etc. The need is made available to the market using guiding information and credit worthiness. Guiding information is the market information about the need including the lowest, average and highest price for the need. Credit worthiness is the financial strength of the buyer. A plurality of sellers bid on the need knowing the guiding information and credit worthiness of the buyer. The need on a successful bid is closed using a seller provided process.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIGS. 1, 1-1, 1-2 are flow diagrams of buying a need from the market. This illustrates the step taken by a buyer to make available a need to the market which is bid by a plurality of sellers, and closing of the transaction using a seller process.

FIG. 2 is a screen snapshot of a buyer with an online presence. This illustrates the tools available to a buyer to make available the need to the market.

FIG. 3 is a screen snapshot of the status of the buyer's needs. This illustrates needs with successful bids, live needs and the different categories available to a buyer to post a need.

FIG. 4 is a screen snapshot of guide selections available to a buyer. This illustrates the guide selections that a buyer can use to become knowledgeable about the market and select a guide selection to make available a need.

FIG. 5 is a screen snapshot of a buyer making available a need with guiding information and credit worthiness. This illustrates the steps taken by the buyer to make available the need to the market.

FIG. 6 is a screen snapshot of a buyer making available a need with guiding information and credit worthiness. This illustrates the portions not visible to the buyer in FIG. 5.

FIG. 7 is a screen snapshot of a buyer making available a need with guiding information and credit worthiness. This illustrates the portions not visible to the buyer in FIG. 5.

FIG. 8 is a screen snapshot of a buyer previewing a need. This illustrates the steps taken by the buyer to preview the need information before posting a need to the market.

FIG. 9 is a screen snapshot of a buyer successfully posting a need to the market. This illustrates the status of the need seen by the buyer on making available a need to the market.

FIG. 10 is a screen snapshot of a need with successful bids. This illustrates the status seen by the buyer on a need closing with a successful bid.

FIG. 11 is a screen snapshot of a buyer closing a transaction. This illustrates the steps taken by the buyer to close a transaction using a seller process.

FIG. 12 is a screen snapshot of a seller process to close a transaction. This illustrates the steps taken by the buyer to close a transaction using a seller process.

FIG. 13 is a screen snapshot of a buyer previewing a seller process to close a transaction. This illustrates the steps taken by the buyer to close a transaction using a seller process.

FIG. 14 is a screen snapshot of a seller updating the transaction status. This illustrates the steps taken by the buyer to close a transaction using a seller process and the status available to the buyer and seller about the transaction.

FIG. 15 is a screen snapshot of a seller registering a business. This illustrates the steps taken by the seller to register a business for bidding on needs in the market.

FIG. 16 is a screen snapshot of a buyer posting a need in three steps. This illustrates another embodiment to show the ease of use posting a need to the market.

FIG. 17 is a screen snapshot of a buyer searching for a need and posting the need in two steps. This illustrates another embodiment to show the ease of use posting a need to the market.

FIG. 18 is a screen snapshot of a buyer doing a search and clicking on the search results to post the need. This illustrates continuation of steps from FIG. 17 to post the need.

FIG. 19 is a screen snapshot of a buyer searching for a term and the results of the search with guiding information. This illustrates another embodiment showing the use of guiding information.

FIG. 20 is a screen snapshot of the search results with guiding information. This illustrates information not visible in FIG. 19.

### REFERENCES CITED

U.S. PATENT DOCUMENTS

| | | | |
|---|---|---|---|
| 6202053 | March, 2001 | Christiansen, et al. | 705/38 |
| 6112190 | August, 2000 | Fletcher, et al. | 705/36 |
| 6088686 | July, 2000 | Walker, et al. | 705/38 |
| 5797133 | August, 1998 | Jones, et al. | 705/38 |
| 6869287 | March, 2005 | Tadlock, et al. | |
| 6850924 | February, 2005 | Grimse, et al. | |
| 5103498 | April, 1992 | Lanier, et al. | 706/58 |
| 6361326 | March, 2002 | Fontana, et al. | |
| 6161099 | December, 2000 | Harrington, et al. | 705/ |
| | | | 36R |
| 6892186 | May, 2005 | Preist | |
| 6873968 | March, 2005 | Ehrlich, et al. | |
| 5960411 | September, 1999 | Hartman, et al. | 705/26 |
| 6647373 | November, 2003 | Carlton-Foss | |
| 4799156 | January, 1989 | Shavit, et al. | 705/26 |
| 4992940 | February, 1991 | Dworkin | 705/26 |
| 5794207 | August, 1998 | Walker, et al. | 705/1 |
| 5826244 | October, 1998 | Huberman | 705/37 |
| 5835896 | November, 1998 | Fisher, et al. | 705/37 |
| 5890138 | March, 1999 | Godin, et al. | 705/26 |
| 5966699 | October, 1999 | Zandi | 705/38 |
| 5995947 | November, 1999 | Fraser, et al. | 705/38 |
| 6012045 | January, 2000 | Barzilai, et al. | 705/37 |
| 6014644 | January, 2000 | Erickson | 705/37 |
| 6026383 | February, 2000 | Ausubel | 705/37 |
| 6058379 | May, 2000 | Odom, et al | 705/37 |
| 6058417 | May, 2000 | Hess, et al. | 709/219 |
| 6260024 | July, 2001 | Shkedy | 705/37 |
| 6301574 | October, 2001 | Thomas, et al. | 707/1 |
| 6584451 | June, 2003 | Shoham, et al. | |
| 6564192 | May, 2003 | Kinney, Jr., et al. | |
| 4789928 | December, 1988 | Fujisaki | 705/37 |
| 6578014 | June, 2003 | Murcko, Jr. | |
| 6499018 | December, 2002 | Alaia, et al. | |
| 6199050 | March, 2001 | Alaia, et al. | |

U.S. PUBLISHED APPLICATIONS

| | | | |
|---|---|---|---|
| 20050171858 | August, 2005 | Cotton, Mark F.; et al. | 705/26 |
| 20050149410 | July, 2005 | Livesay, Jeffery A. | 705/26 |
| 20050144115 | June, 2005 | Brett, Kenton F. | 705/37 |
| 20050131809 | June, 2005 | Watt, William R. II; et al. | 705/37 |
| 20050131797 | June, 2005 | Ananthanarayanan, Rema; | 705/37 |
| 20050131724 | June, 2005 | Clay, Danny | 705/1 |
| 20050091144 | April, 2005 | Longman, Robert; et al. | 705/37 |
| 20050097036 | May, 2005 | White, Brigette A.; et al. | 705/39 |
| 20040138995 | July, 2004 | Hershkowitz, Brian | 705/38 |
| | | F.; et al. | |
| 20040138993 | July, 2004 | DeFrancesco, James; et al. | 705/38 |

### OTHER REFERENCES

1. Wilder, Clinton, “What's Your Bid?—FreeMarkets'Real-Time Online Bidding Technology Lets Clients Drive Down Costs, Information Week, Issue: 656, Nov. 10, 1997
2. Dynamic Pricing—Reverse Auctions, http://www.managingchange.com/dynamic/auctions.htm
3. Internet Auctions, Everythingexplained.com, http://www.everythingexplained.co.uk/auc02.htm#gen
4. www.bizrate.com, http://www.bizrate.com/buy/browse_{——}cat_id--499.html
5. Teletrade's real price guide, www.teletrade.com, http://www.teletrade.com/coins/search.asp?pguide=1
6. Internet Auctions—Popular and Professional Literature Review, Quarterly Journal of Electronics Commerce, 2002
7. consumerreports.org, ratings and reports

### PARENTS CASE TEXT

### CROSS-REFERENCE TO RELATED APPLICATIONS

This application claims priority of U.S. provisional application, No. 60/603,922, titled “Obtaining A Need With Guiding Information And Credit Worthiness Using A Competitive Process” filed Aug. 23, 2004 by the present applicant.

This application refers to the provisional application, U.S. No. 60/612,272, titled “Using Popular IDs To Sign On Creating A Single ID For Access” filed Sep. 2, 2004 by the present applicant.

This application refers to the provisional application, U.S. No. 60/653,349, titled “Intelligent Searching With Guiding Info” filed Feb. 16, 2005 by the present applicant.

This application refers to the provisional application, U.S. No. 60/656,645, titled “Guiding Info Tabs With Guide Selection” filed Feb. 23, 2004 by the present applicant.

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application—and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

Auctions are ways to create a market for selling and buying needs. Needs could be consumer items like TVs, Trading Cards, etc., or loans like auto loans, mortgage loans, or it could be exotic items like land, art, etc. A need from a seller perspective would be to sell an item that they possess. A need from a buyer perspective is to obtain possession of such a need. There are many types of auctions. A normal auction is a way for a seller to sell possession of an item that they own. A reverse auction is a way for a buyer to make available a need to the market and obtain that need at a reasonable price. The need could be consumer items like a new TV, MP3 players, or loans, or art, etc. The reverse auction process can be beneficial to both the buyer and seller if market prices are made known when the need is posted. This avoids the problem wherein a buyer might make available a need or buy at above market prices, making the need expensive. It also avoids the problem of collective selling wherein the sellers can organize themselves for better market prices.

The present invention makes available a need with guiding information and credit worthiness. Guiding information is the competitive market information that is made available to the buyer as well as to the seller. Credit worthiness could be the FICO score or credit rating score, showing the financial strength of the buyer. The need is made available using the reverse auction process so that a plurality of sellers could bid on the need making it competitive.

The guiding information made available to the buyer could be expert information about the need including the lowest, average and highest prices for a need. For e.g., for a mortgage loan need, the current interest rates, lowest, average, and highest interest rates for a mortgage loan product could be made known. The lowest and average prices made known could be for a region, with the region covering all of a country or a particular area. The local lowest and average prices could also be provided to help guide the buyer about the local prices. Guide selections available help guide the buyer about the market. Guide selections are popular choices of products making it easier for the buyer to just select one of the guide selections to make available the need. The buyer uses guiding information and guide selections to make available the need for a new Television or MP3 player or a mortgage loan or an auto, etc. available to the market. The buyer could select the average price or the lowest price for making available the need. If the buyer chooses the average price, then the need becomes competitive and many sellers might get interested in the need as there is a price difference and a gain that could be made. If the buyer makes available the need at the lowest price, then only a few sellers might be interested in bidding on the need. If there is an upward movement in market prices after the need is made known then the need might not get bid on, but if there is a downward movement in prices, then the need becomes attractive again and could be bid on by many sellers. The downward movement could be due to a sale or a holiday season, etc. The guiding information provided helps the buyer become knowledgeable about the need and the market for the need before it is made known. This avoids the problem wherein the buyer is unaware of the market for a product and could spend a lot of time researching the product and the market prices for it, or over pay for a product, and not feel satisfied that the price paid is reasonable.

The credit worthiness information presented along with the guiding information helps the seller bidding on a particular need like mortgage loans, auto sales, etc. know the financial strength of the buyer before making a bid on the need. The need could be for a mortgage loan, auto loan, etc. The financial strength of the buyer can be used to determine the rate/price offered. A buyer with strong financial strength can be offered better rates/prices than a buyer with a questionable financial strength. Knowing the financial strength before bidding avoids the problem of guessing the strength or trying to get the financial strength later and having to change or not being able to honor a winning bid.

The present invention also provides real time collaboration tools available to the buyer and seller so that they could interact if more information is needed. The collaboration tools could be IM, VoIP, SMS, etc.

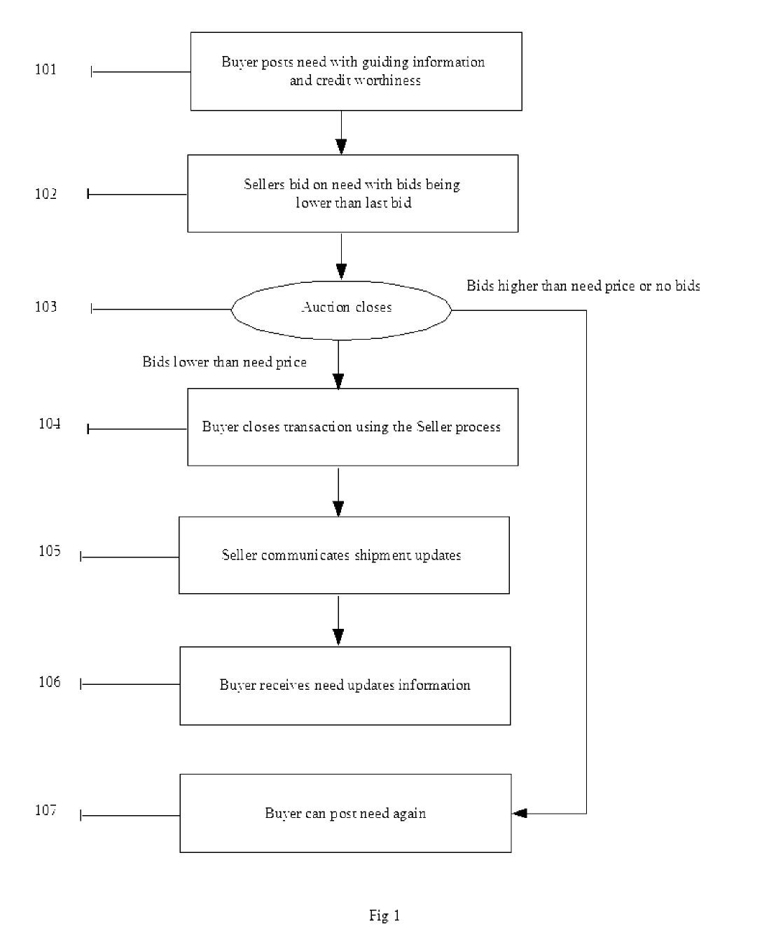

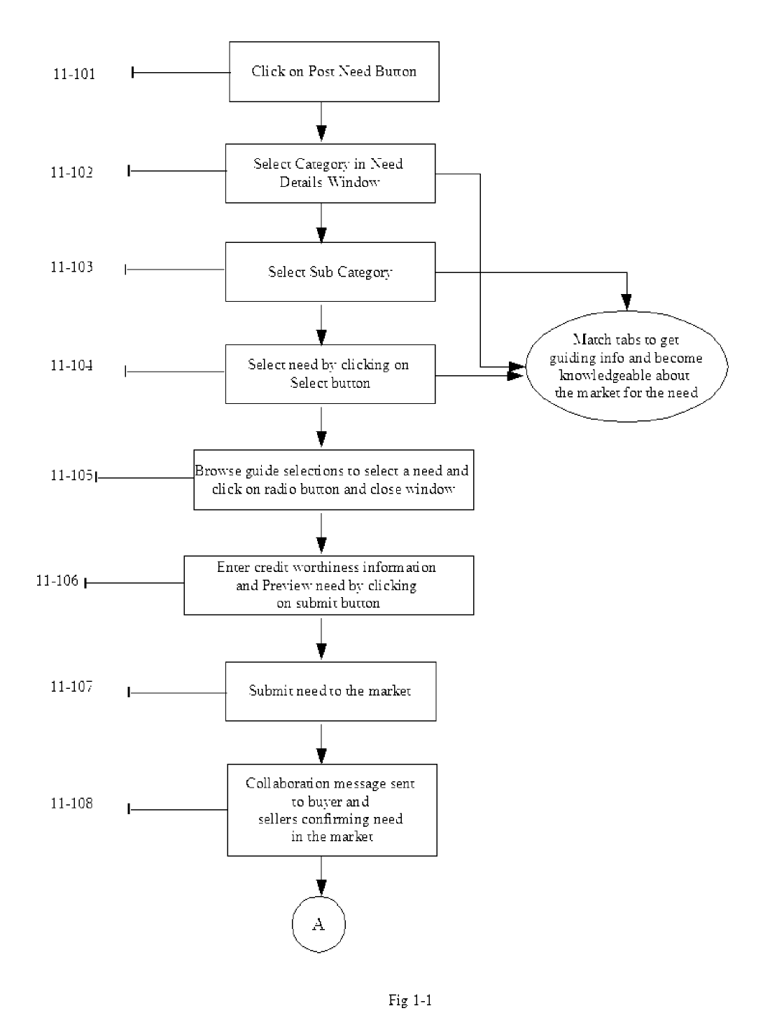

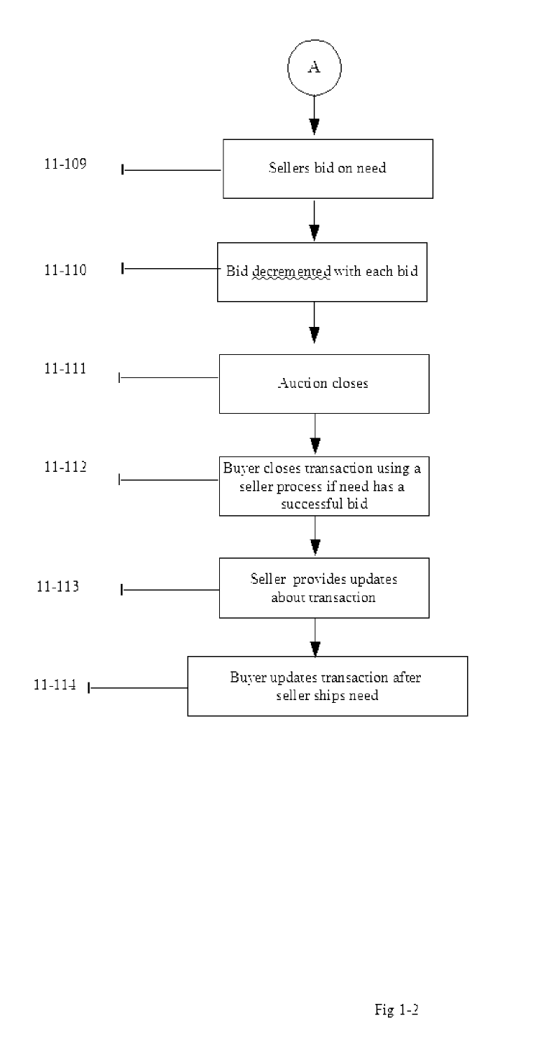

FIG. 1 is a flow diagram illustrating a method the buyer goes through for obtaining a need according to a specific embodiment of the present invention. In the first block 101, the buyer posts a need using guiding information and provides the credit worthiness information to show the financial strength. The need is made available for a known period. Block 102, shows sellers bidding on the need with each bid being lower than the last bid. As bids increase, the price keeps moving down. Block 103 shows the close of the auction at the end of the known period. At the close, if there are bids, and the bids are lower than the need price, the auction is successful. If there are no bids, and the bids are higher than the need price, the auction is not successful, and the buyer can post the need again. If the auction is successful, in block 104, the buyer closes the transaction using a seller provided process. The seller processes the transaction and starts shipment of the need to the buyer in block 105. The seller communicates the shipment, receipt, etc. to the buyer. The buyer on receiving the need updates the status of the receipt of shipment.

FIGS. 1-1 and 1-2 are flow diagrams illustrating the steps followed by a buyer and a plurality of sellers to make available a need and make bids on the need. The steps are illustrated with screen snapshots of an online market place to present the invention.

FIG. 2 is an illustration of the online marketplace provided by ENeedsOnline according to a specific embodiment of the present invention. 201 is the online marketplace where a buyer can post a need. 202 is an online user who has signed in using the ENeedsOnline login mechanism. ENeedsOnline is an ecommerce portal that provides an online presence to a user. The user gets an online presence by signing on, see invention “Using Popular IDs To Sign On Creating A Single ID For Access”. 203 is the collaboration tools provided to a user of ENeedsOnline. Tools like IM, SMS, Email, etc. are available.

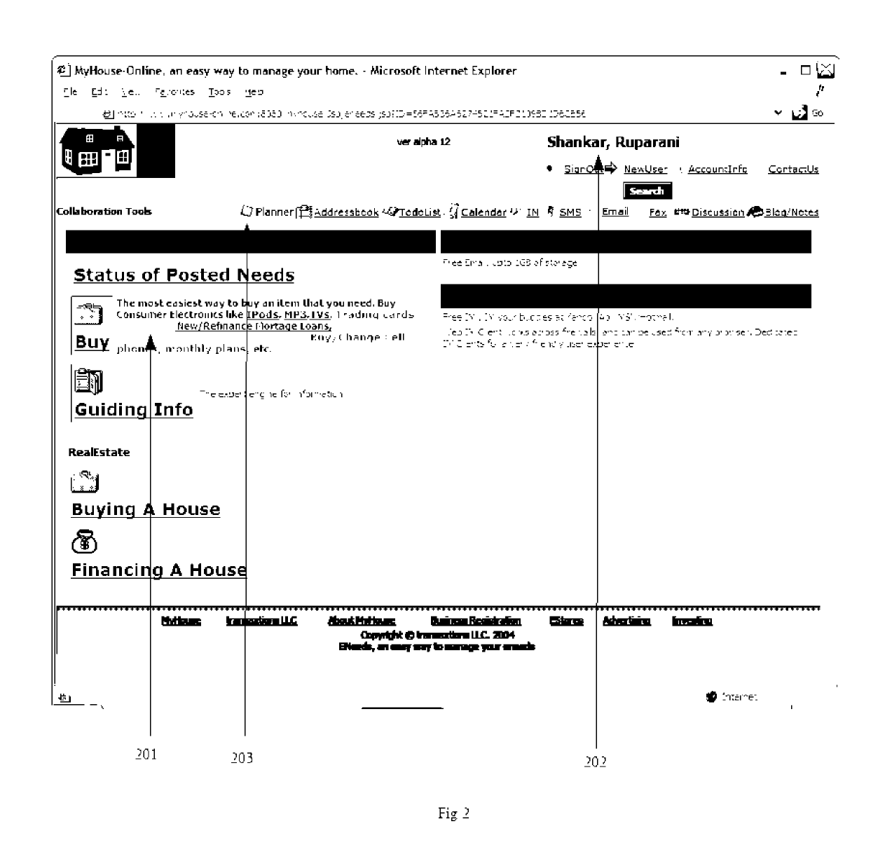

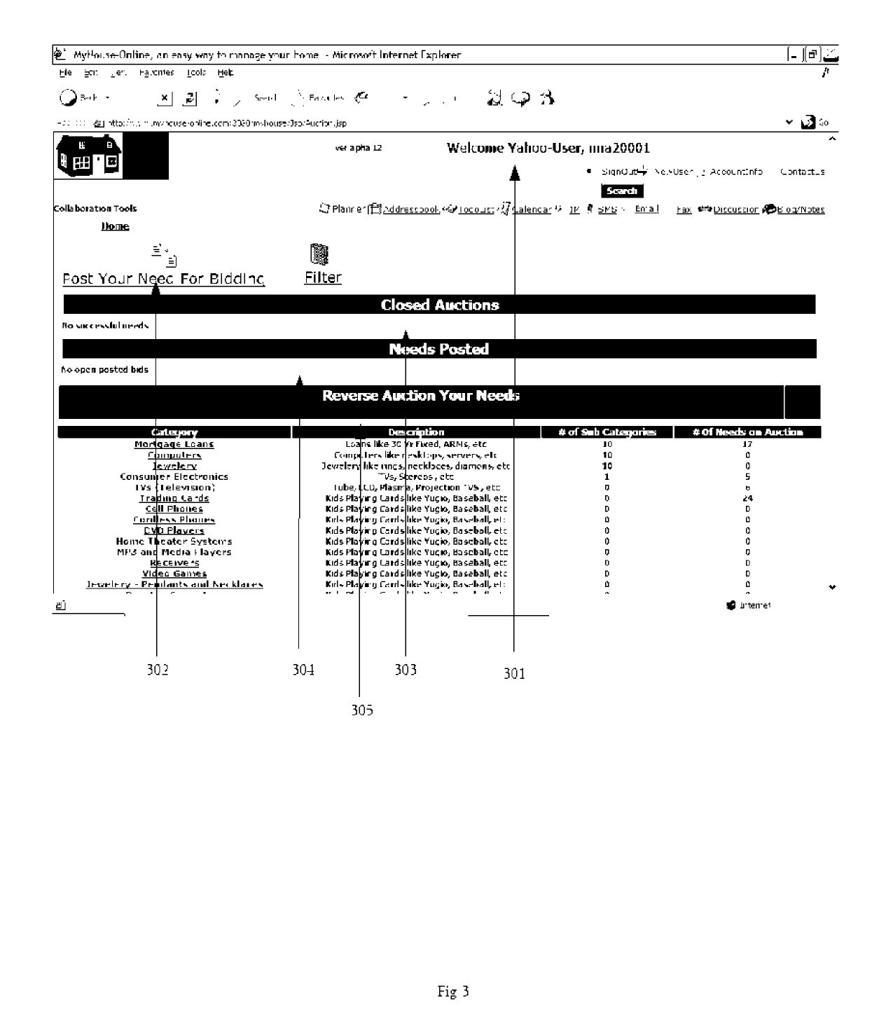

FIG. 3 is an illustration of ENeedsOnline when a buyer selects the “Buy” option 201 to post a need for bidding according to a specific embodiment of the present invention. 301 is the buyer with an online presence. 302 is the option to post a need for bidding. 303 shows closed auctions. “Closed Auctions” are auctions where the buyer had previously posted needs that have successful bids as in 104. 304 show needs that have been posted and are still available for bidding. 305 shows the reverse auction categories available to the buyer to post a need to the market.

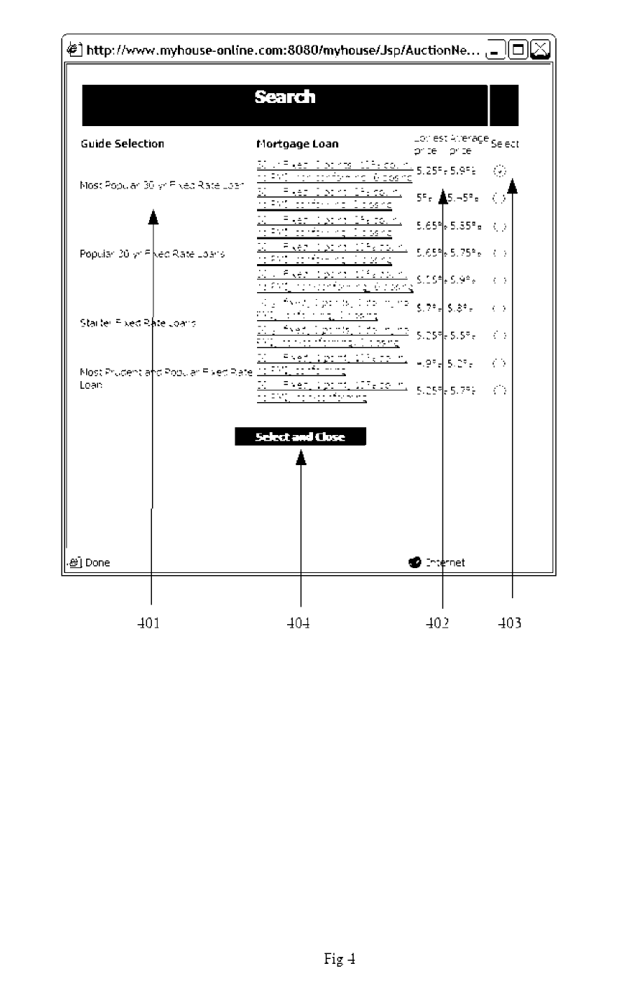

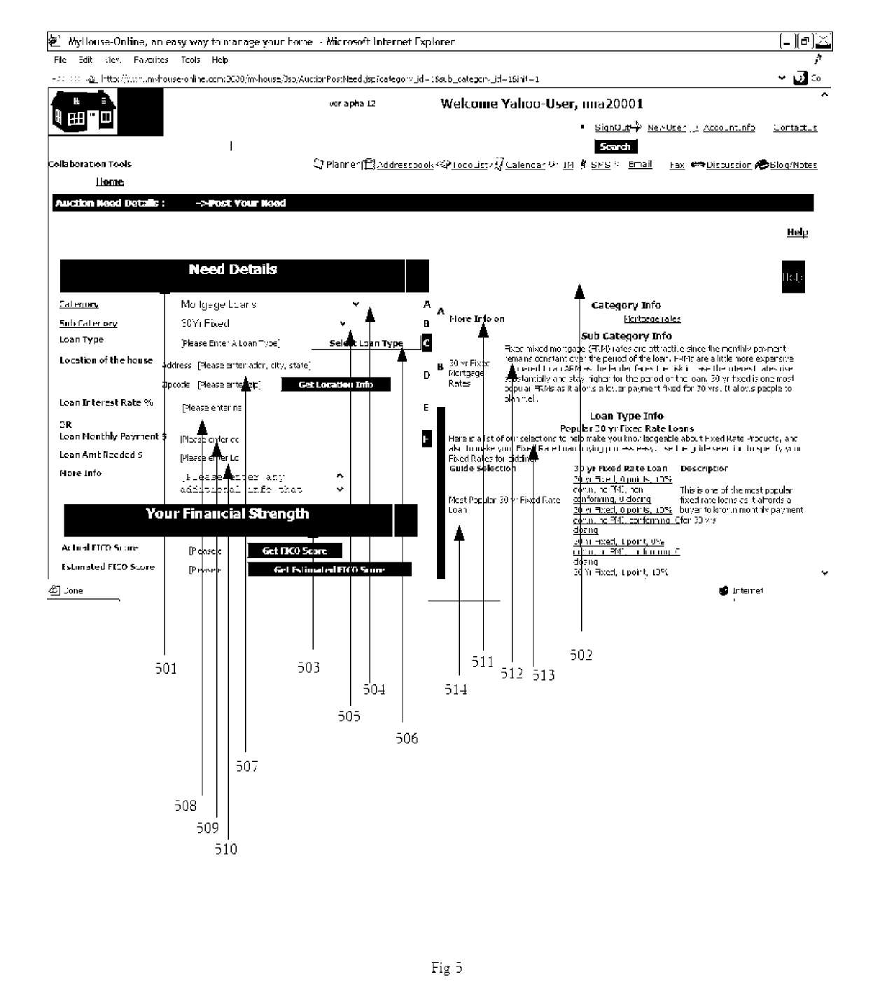

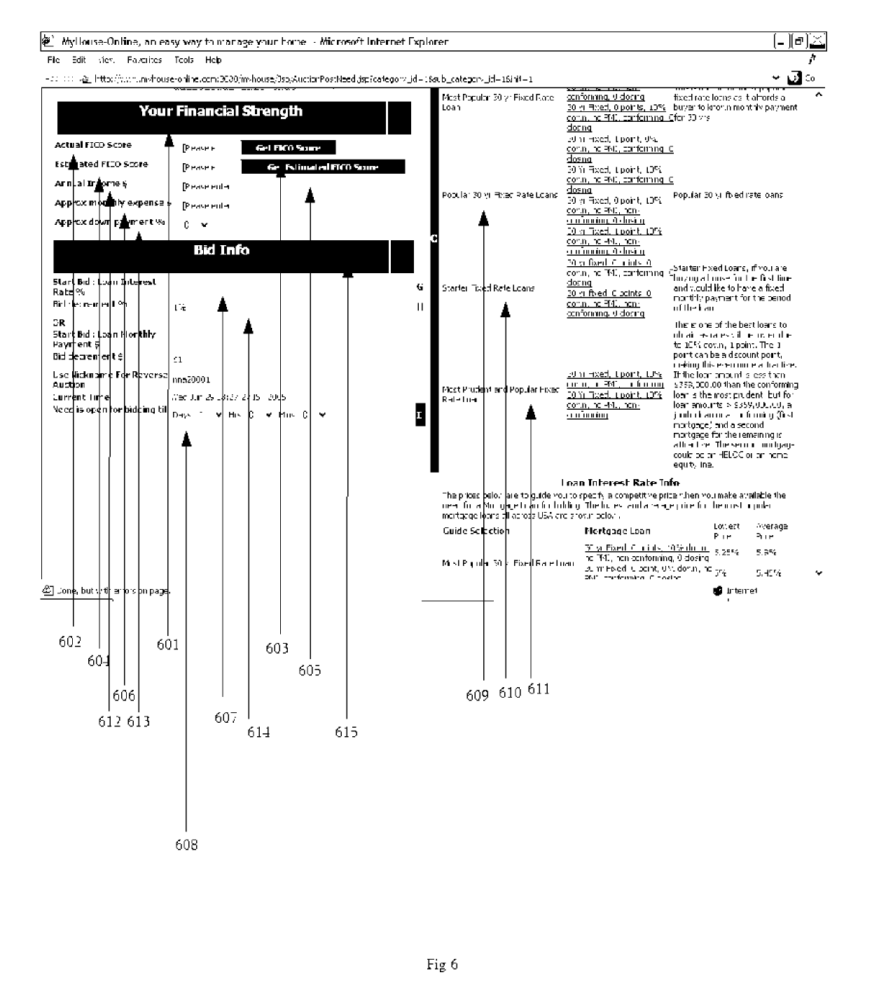

FIG. 4 is an illustration of the guiding information search window according to a specific embodiment of the present invention. The search window shows the lowest rates and average rates for “Fixed 30 year loan” products. 401 is the ENeedsOnline guide selections for “Fixed 30 year loan” products. 402 is the lowest and average rates for the guide selections. The rates shown are for a region which could be as big as all of USA. 403 is the option to select one of the guide selections. 404 is used to close the search window and transfer the contents of selected option to the “Need Details” window 501 described below.

In the described embodiment, the search window shows only ENeedsOnline guide selections, but this could be changed to include other selections. A search option could also be provided to search for more products in other embodiments.

FIG. 5 is an illustration of ENeedsOnline when the buyer selects 302, step 11-101 from FIG. 1-1, and shows a need being made available to the market according to a specific embodiment of the present invention. 501 is the “Need Details” window showing the buyer posting a need for a “Mortgage Loan”. 502 is the “Guiding Information” window, 503 is the “Financial Strength” window. The buyer first chooses the category, “Mortgage Loans” 504, step 11-102 and then chooses the sub category “30 year fixed rate loan” 505, step 11-103 under “Mortgage Loan”. The buyer can get more information about the category or sub category by matching the category tab to the guiding information tab. The tabs are color coded along with a code alphabet so that the user can visually match the information as needed, see invention U.S. 60/656,645, “Guiding Info Tabs With Guide Selections”. The buyer then selects “Select type”, step 11-104 option to choose the loan type. Clicking on “Select Type” brings up, a search window, as described in FIG. 4 embodiment. The buyer chooses one of the options by clicking on the select radio button, step 11-105. The buyer closes the window to transfer the selected option to the need details window fields like “Loan Interest Rate” and “Loan Amt. Needed”. The Bid Info window fields “Start Bid Decrement” and “Bid Decrement” are also automatically populated. If the buyer has decided on a house or is refinancing for an existing house, then the buyer enters the house address, 507. The “Loan Interest Rate” field, 508 is populated with average interest rate for the loan product, but this could be changed by the buyer to the lowest interest rate or any other value desired by the buyer. The buyer then changes the loan amount field, 510 to the desired loan amount needed. The buyer also has the option of entering the monthly payment desired using monthly payment field, 509. The field names like “Loan Interest Rate”, “Loan Amt. Needed”, “Loan Monthly payment” are specific to this embodiment and change with change in category and sub category to make it easier for the buyer to the enter the “need” information.

Once the buyer completes the Need Details window, the buyer can enter the credit worthiness information in the “Your Financial Strength” window 601, step 11-106. The following fields are shown in this embodiment, “Actual FICO score” 602, “Estimated FICO score” 604, “Annual Income”, “Approx monthly expense” and “Approx down payment”. 602 is the FICO score provided by Fair Issac, Corporation, and is based on many parameters which are taken into account. This score is usually obtained by the Mortgage broker, bankers, and lenders after taking the loan applicant's personal information. Applying for a loan with multiple lenders mean each of these lenders will obtain the FICO score from a credit bureau. The access of the credit report by multiple lenders affects a buyer's credit score and can actually lower the credit worthiness of the buyer. To avoid this, the buyer provides this score if known, if not, by obtaining it using option 603. The buyer can also provide an estimated FICO score, 604. This is not the actual FICO score but an estimation of the FICO score using a FICO calculator. The estimated FICO score can be obtained using option 605. The buyer can also provide additional financial support information like “Annual Income” 612, “Approx Monthly expense” 606 and “Approx down payment” 613, so that a seller of a loan has most of the needed info to bid on the buyer's need for a loan.

The “Bid Info” window 615 allows the buyer to specify the start bid amount and the bid decrement. The start bid rate 607 and the bid decrement 614 fields are automatically populated with the average price when the loan type is selected. The buyer could increase this, but not lower it than the needed price. The buyer can then set the duration of time that the need is available to the market using option 608. The buyer can use this to set a lower price for a need and set the duration to end after holidays. For e.g. the buyer could target the “after holiday sale”, after December 25, as sellers usually try to sell all the left over inventory at cheaper prices.

The buyer uses the guiding information available in 502 to make available the need, knowing the market prices for it. 511 provides more information about the category, while 512 provides more information about the sub category. 513, 609, 610, 611 are guide selections provided by ENeedsOnline and allows the buyer to easily become knowledgeable about the various products available in the market. Guide selections as described in invention U.S. 60/656,645, “Guiding Info Tabs With Guide Selections” makes it easier for a buyer to become knowledgeable about a product. Guide selections are popular choices of products and information that enables the buyer to make the choice of selecting a product very easy. FIG. 7 is a continuation of the screen snapshot of FIG. 5 embodiment and provides information about the “Loan Interest Rate” info. The “Loan Interest Rate Info” 701 is specific to the “Mortgage Loans” category and could change with a change in category. 703, 704 are the lowest and average price for the guide selection 702. The prices shown are specific to a region; the region could be all of USA. The lowest and average price tell the buyer the current prices for a product across the region and allows the buyer to make the need available at the average price increasing the chances of sellers bidding on the need. The buyer could use the lowest or make the need lower than the lowest price but the number of seller bidding on the need would be less. The buyer could make available the need at a lower price and set the duration of the need to end just after the holidays so that sellers disposing inventory will sell at below sale prices. The guiding info in this embodiment does not show the local low and average prices but this could be shown in another embodiment and needs the zip code field in 501 to be populated.

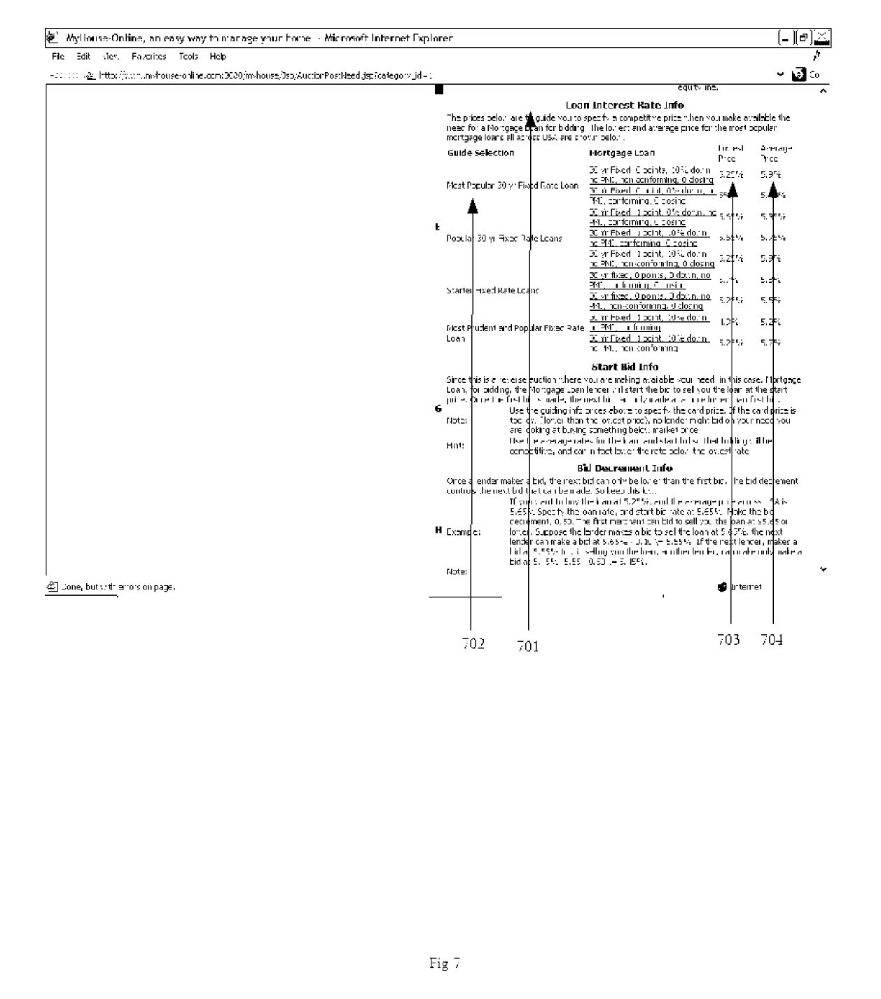

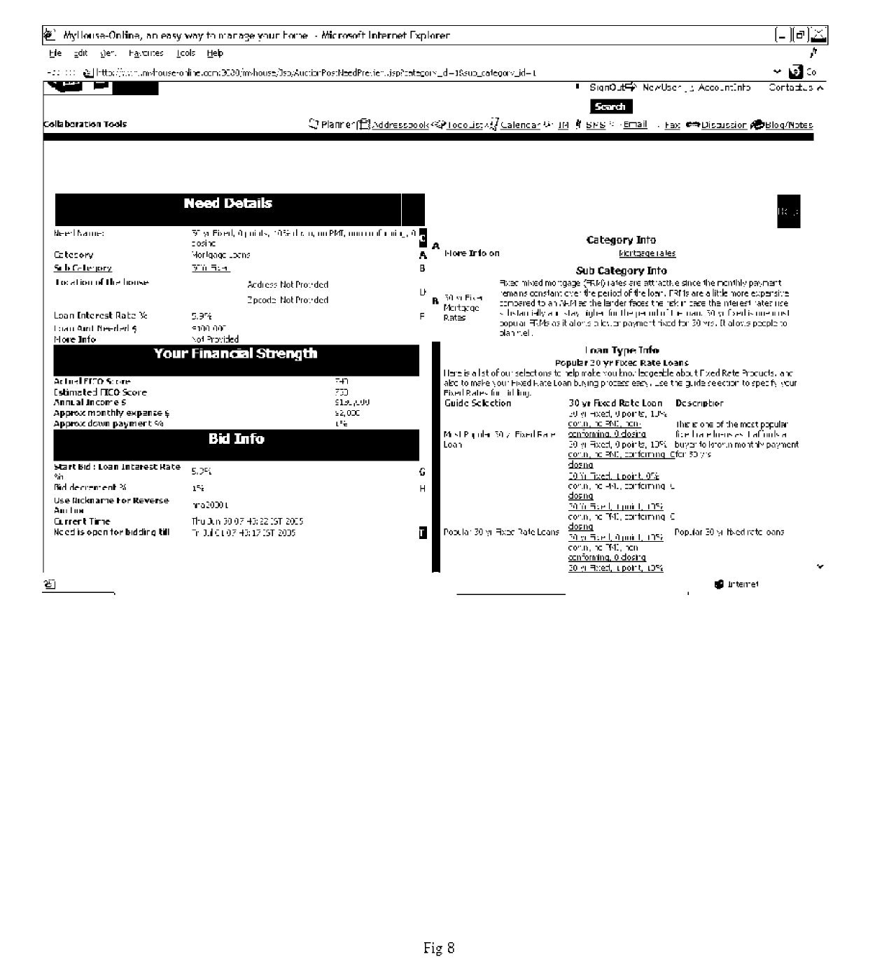

FIG. 8 is an illustration of the buyer previewing the need info before submitting the need to the online market place for the sellers to bid on the need. On pressing the submit button, step 11-107, the submitperformed method in the AuctionPostNeedPreviewController object instance gets control. First a new need id is generated by calling DatabaseUtil.generateId(“need_id”), next the session object associated with the buyer is retrieved by invoking getSessionManager( ).getWebSiteUser(getCurrentRequest( ).getSession( )). The need information stored in the session is retrieved by retrieving the HashMap objects with keys “VALUES”, and “INIT”. The data types associated with the embodiment are retrieved using the key “DATATYPES”. This retrieves a SubCategoryHdrs object instance. The HashMap object associated with “VALUES” key holds the need information like need_name, address, need_rate, need_desired, afico, efico, guiding_info, start_bid_need_rate, bid_decrement_need_rate are retrieved and stored into a datastore using JDBC st.executeUpdate method. The sub category and category information in the datastore are updated to show the number of needs on auction. A message is sent to the “PostNeedTopic” that a new need has been made available to the market. This message is then used to send emails, IM, SMS or VOIP to the buyer and sellers that the need has been posted and available at the market, step 11-108.

It should be noted that in the described embodiments, an object oriented programming environment has been described to discuss the present invention. Object Oriented constructs such as methods, object, instance, attributes, and exceptions have been used to describe how the invention works. However, this can also be implemented in other programming environments and languages. It should also be noted that this is an illustration of one of the embodiments. The elements can be retrieved using other methods, and rendered or passed on to other methods or objects and should not be limited to as shown.

FIG. 9 is an illustration of the need having been successfully submitted to the market. 901 is the success message that the need has been submitted. 902 and 903 show the details of the need and the need id which the buyer keeps track off. 905 shows the duration that the need is available to the market and 904 shows that no bids have been made on the need. An email is automatically sent to the buyer and the sellers who have registered for the category and sub category about the need being successfully submitted, and that the need being available in the market. IM or SMS or VoIP can also be used to automatically deliver the submission in another embodiment.

The sellers now bid on the need, step 11-109. The first bid can be made at the start bid price or lower. Each new bid can be made at a decrement or lower. The decrement is set by the buyer. The sellers can make bids until the end of the auction duration. The sellers can make a bid by clicking on the URL sent in the email or by clicking on the option “Sell/Bid” from the marketplace. Clicking on the URL takes the seller to the Need Details Window for the seller 1101. The seller can see the need details and guiding information used by the buyer. The seller can choose the default bid parameters and post the bid or change the bid by lowering the automatic bid calculated by the system, step 11-110. The sellers can make bids until the close of the auction.

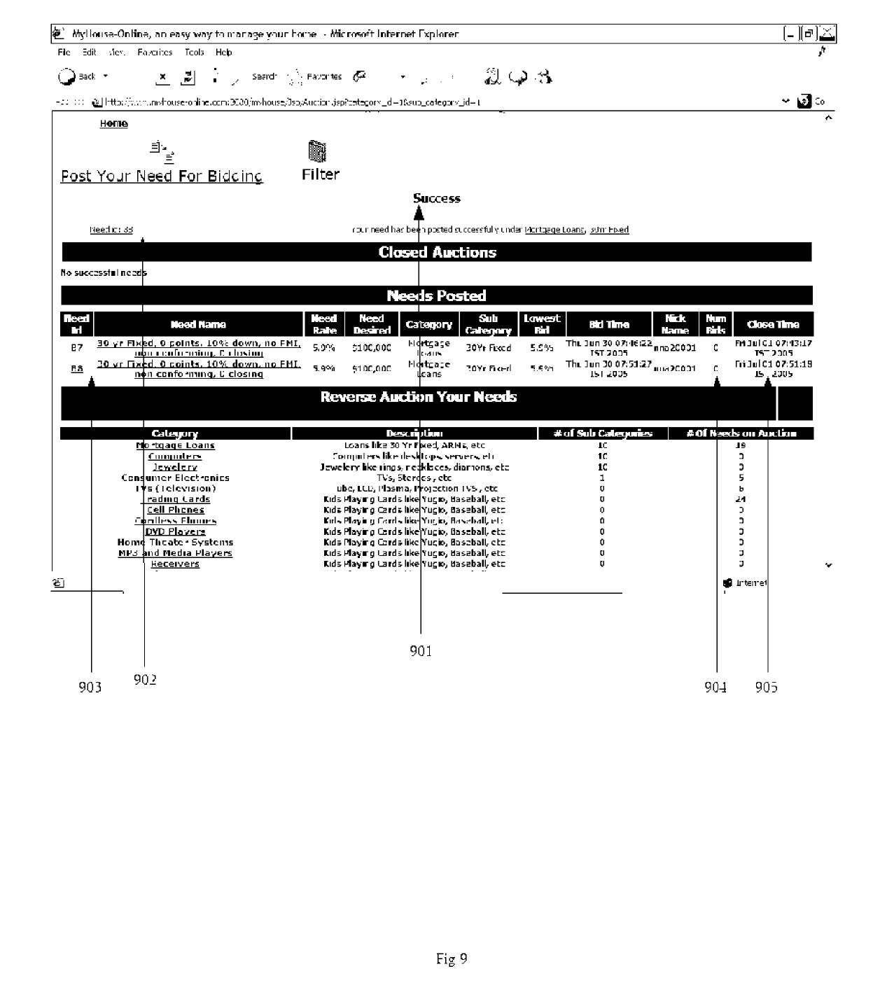

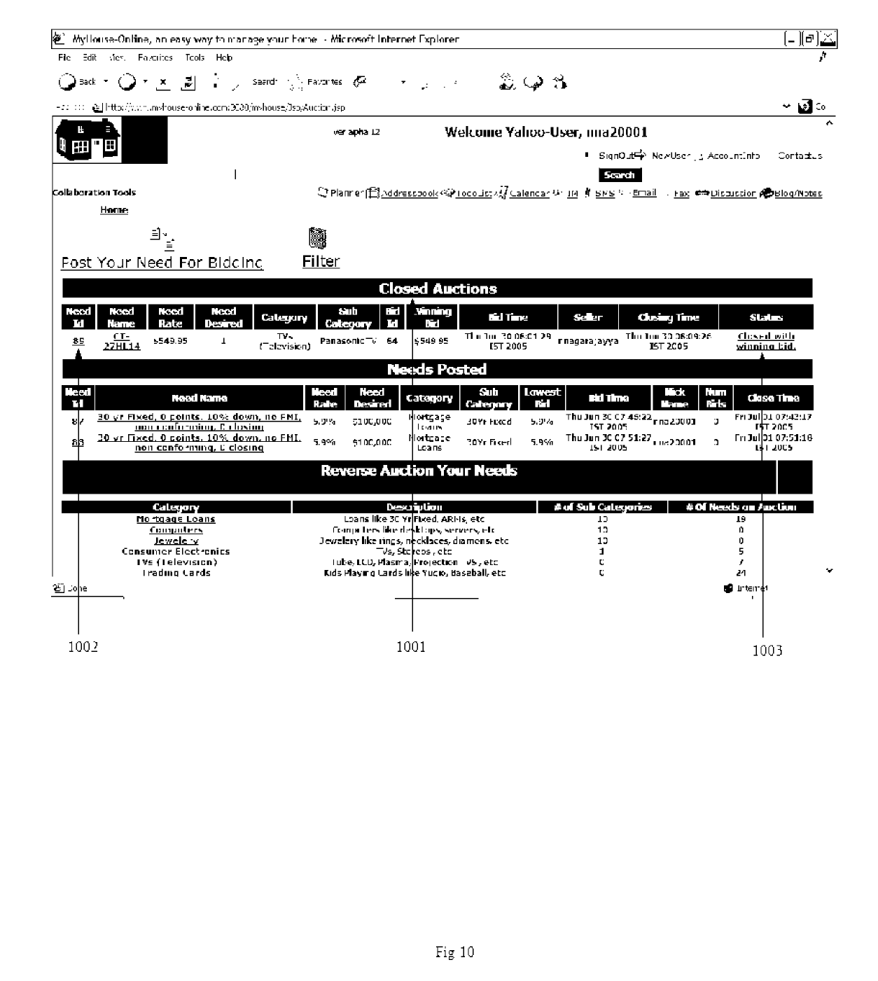

FIG. 10 is an illustration of a need with a successful bid according to a specific embodiment of the present invention. 1001 shows the list of needs that have closed successfully, step 11-111. 1002 the need id that has closed successfully with a winning bid 1003. Clicking on 1002 or 1003 link takes the buyer to close the transaction.

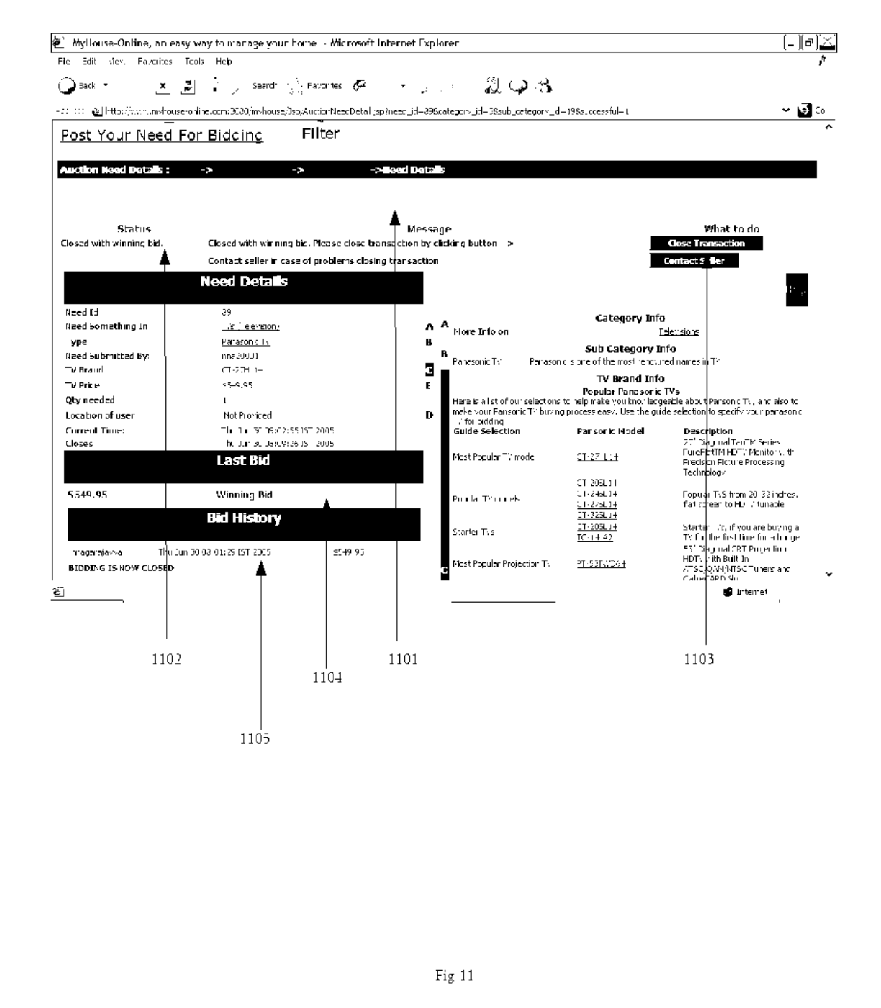

FIG. 11 is an illustration of a need after the buyer has clicked the link 1003 or 1002 to close the transaction, step 11-112. 1101 is the need under bid window showing details of the need with a winning bid 1104 from a seller. 1102 shows the status and 1103 allows the buyer to close the transaction by clicking on the “Close Transaction” button. Clicking on 1103 takes the buyer to the seller process for closing the transaction. The seller registers the process to close a transaction at seller registration. 1105 is the bid history and shows all the bids made by different sellers.

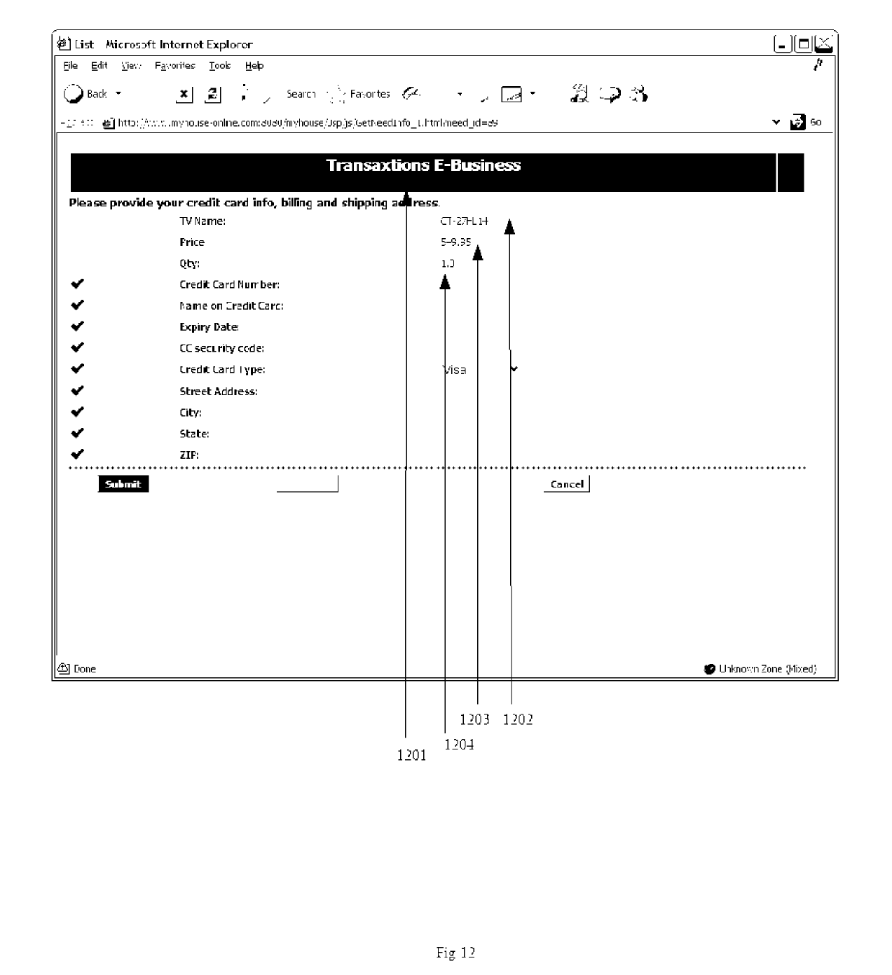

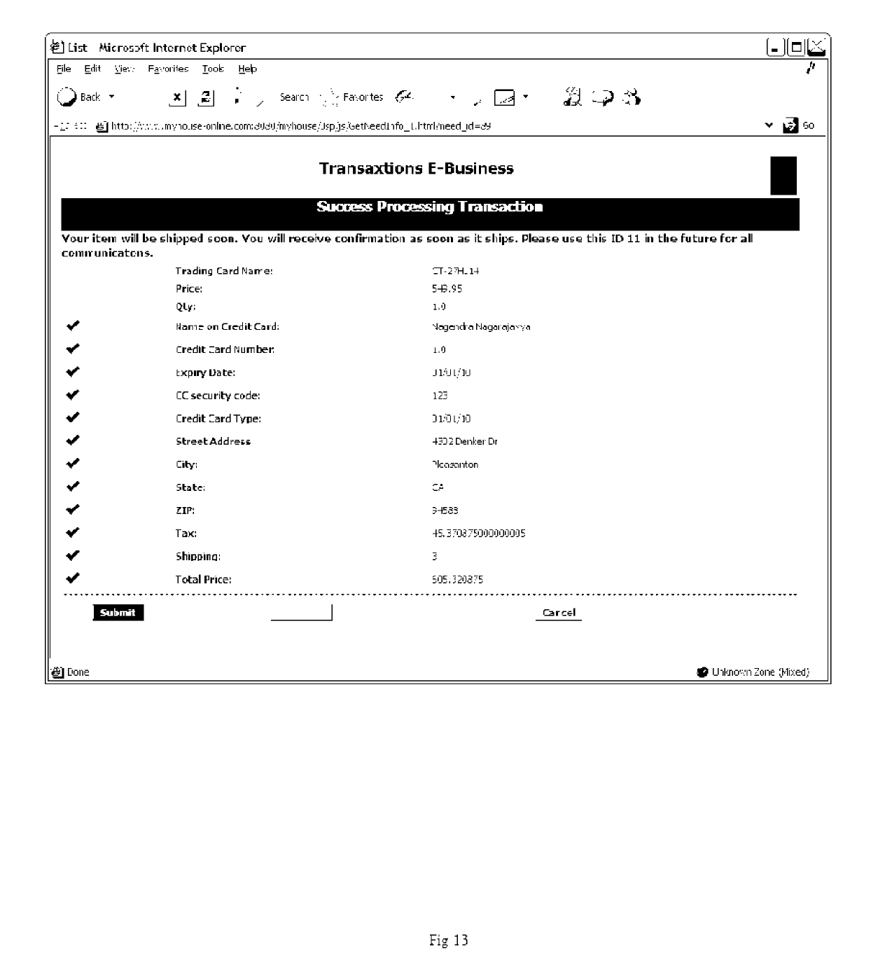

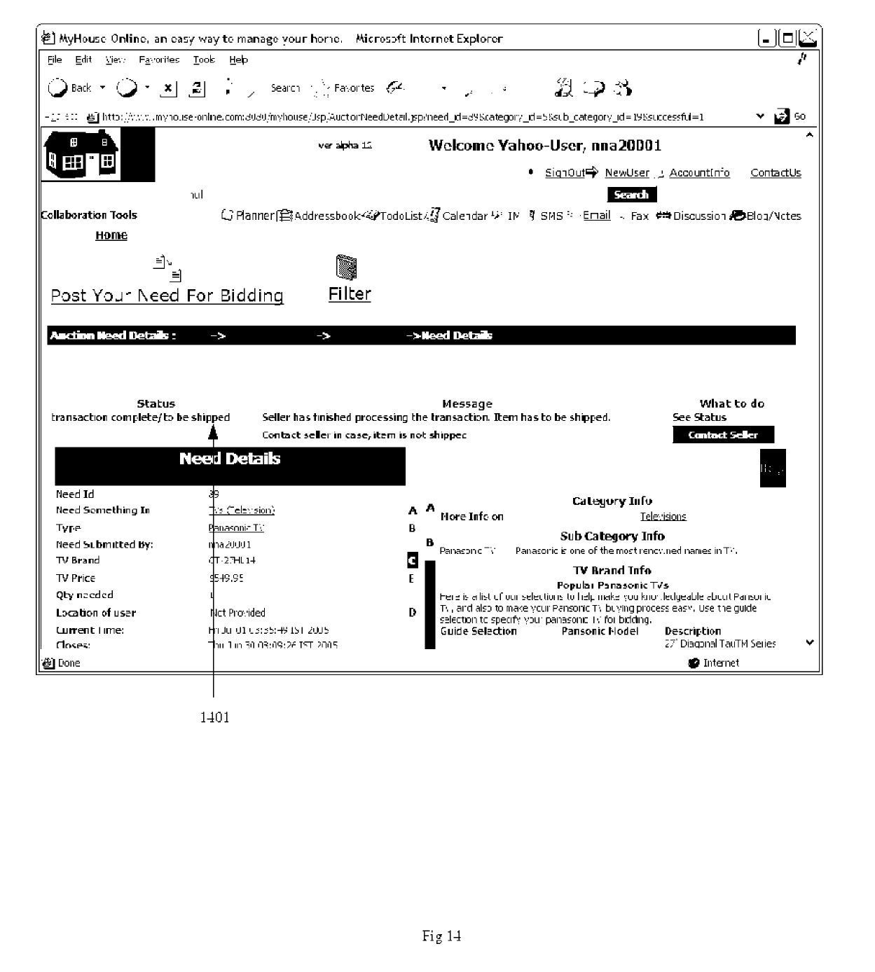

FIG. 12 is an illustration of a seller process to close the transaction. 1201 shows the seller business, 1202, 1203, 1204 fields are automatically populated with the need information and the winning bid price. The buyer has to provide information like credit card information to close the transaction. FIG. 13 is an illustration of the buyer having filled up the credit card information fields submitting the information successfully. Once the buyer completes this successfully, the seller sends a message that the transaction has been closed by calling the http://www.ENeedsOnline.com/Jsp/TransactionClosedSuccessfuly.jsp?need_id=need_id. The seller also sends another message once the item has been shipped by calling http://www.ENeedsOnline.com/Jsp/ItemShippedSuccessfullyjsp?need_id=need_id, step 11-113. The buyer can see these messages by accessing 1002 or 1003. FIG. 14 is an illustration of the buyer viewing the status of a need being shipped. 1401 is the status of the need showing transaction complete and item is to be shipped. Once the item is shipped and reaches the buyer the buyer can update the status of the transaction as received successfully and provide feedback on the process, step 11-114. The feedback is made available to the seller also.

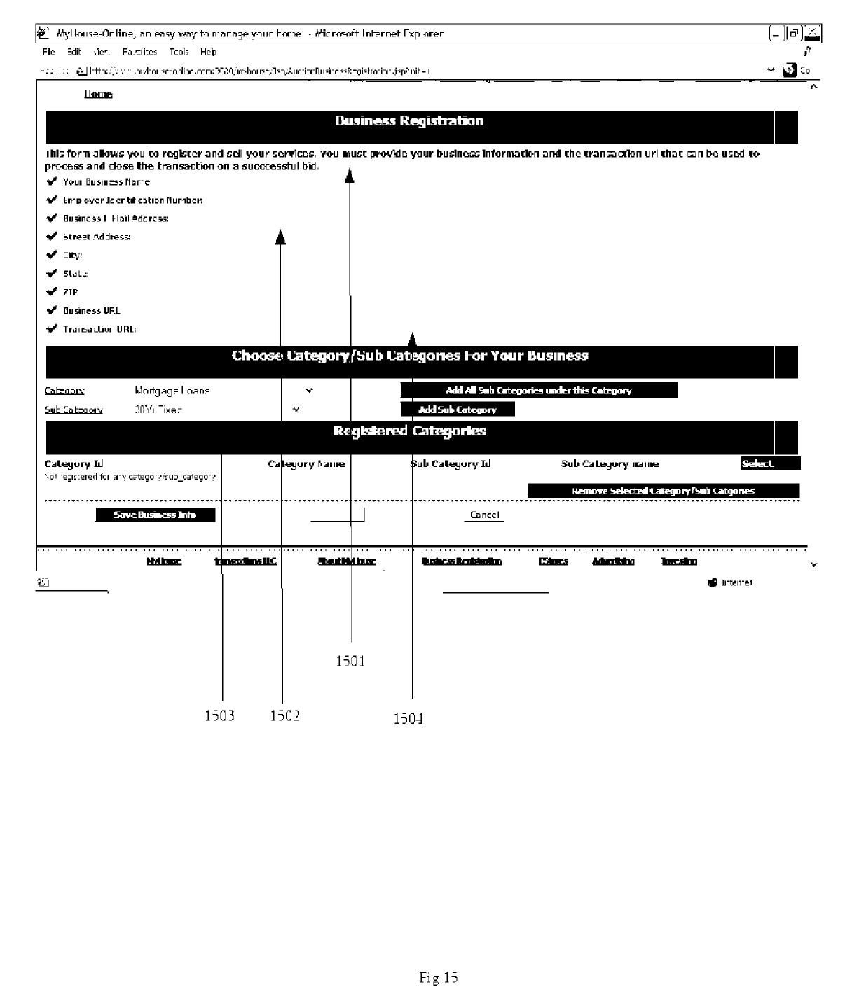

FIG. 15 is an illustration of the Business Registration that a seller goes through to register for bidding on needs at ENeedsOnline. 1501 shows the different fields that need to be populated and 1502, 1503 show the category/sub category that a seller can register to bid. 1504 shows the transaction URL that a seller provides that will be used to transfer control to close a transaction. ENeedsOnline provides a call back javascript that gets executed when the control is transferred to this URL. The call back script calls AuctionGetNeedinfojs.jsp?need_id=<id>. The <id> is populated with the need_id of the request by obtaining this from the URL. The AuctionGetNeedinfojs.jsp transfers control to the AuctionGetNeedinfojsController object instance pageRequested method. The following javascript variables are set so that it is available to the seller needname, category, sub_category, bid_price, and need_desired. The seller can use these global javascript variables to directly populate fields in the transaction URL form. The described embodiment uses javascript to pass information making it easier for the seller to process and close the transaction. This could also be implemented in other ways in another embodiment like using XML to pass the need information or passing the information through GET and POST methods parameters.

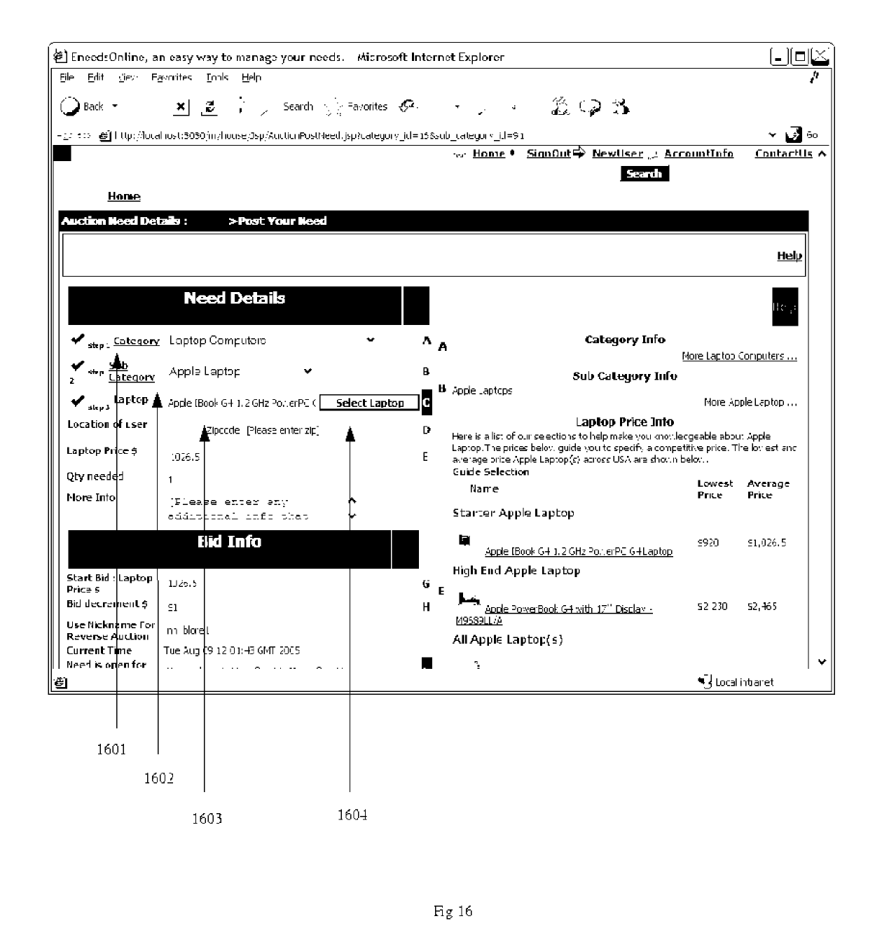

FIG. 16 is an illustration of three steps to post a need according to a specific embodiment of the present invention. FIG. 16 is similar to FIG. 5 and illustrates a buyer posting a need in just three steps. In step 1 1601, the buyer chooses a category, in step 2 1602, the buyer chooses a sub category, and in step 3 1603, the buyer selects a product using the select button 1604 and posts the need to the market.

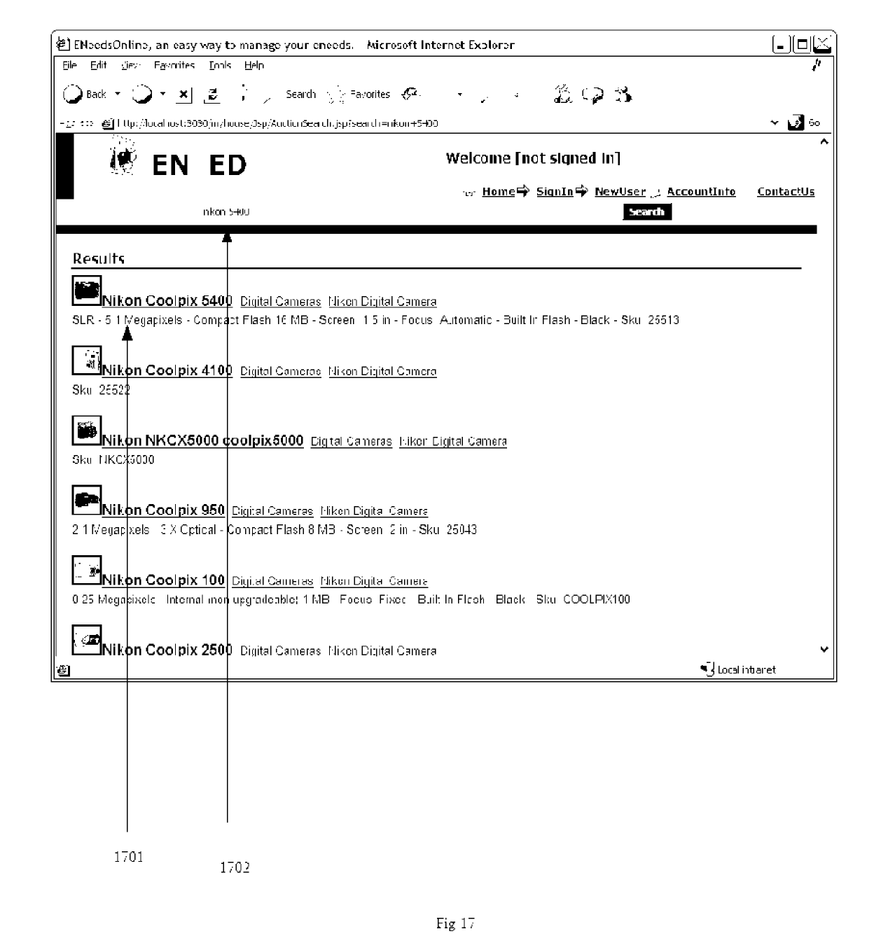

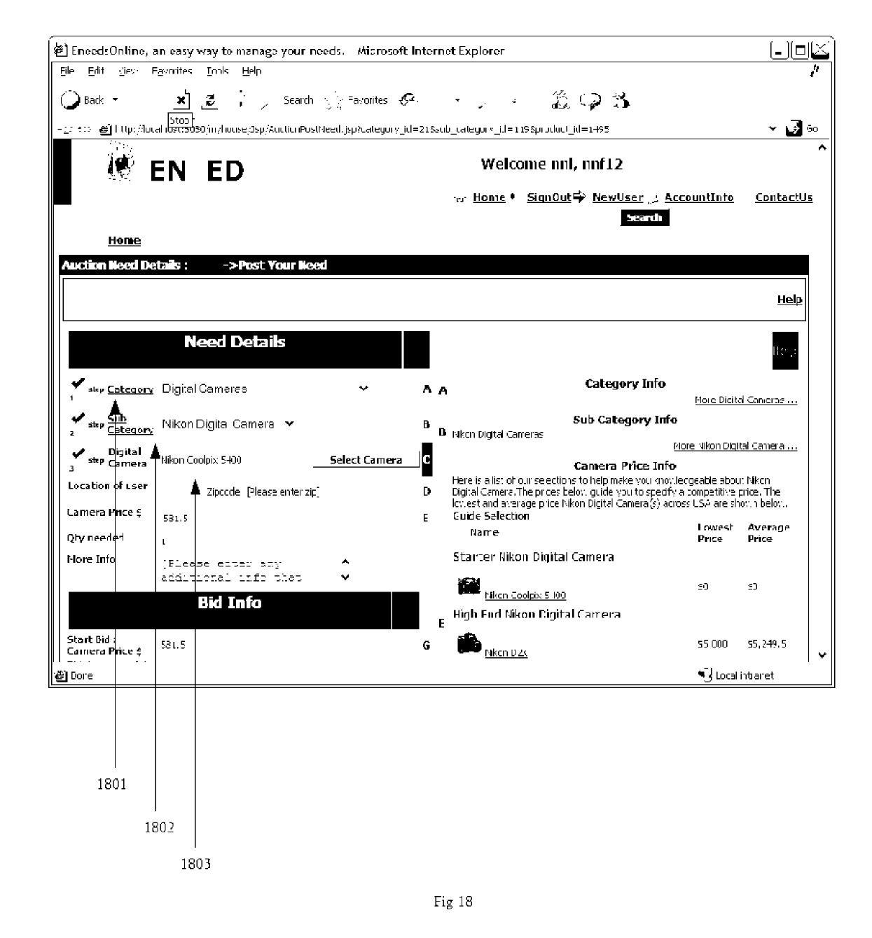

FIG. 17 is an illustration of two steps to post a need according to a specific embodiment of the present invention. In step 1, the buyer searches for a need by entering “Nikon 5400” in the Search Text box 1702, and in step 2, the buyer clicks on the returned results 1701 to fill up the need details with the selected product and post the need to the market. 1701 shows the products returned by the search. The first column shows the image, second name of the product, third, category and the fourth the sub category. This embodiment shows only a few columns but in another embodiment other columns like seller, buyer, low and average price, etc. might be shown. FIG. 18 is an illustration of the buyer clicking on the second column of the first search result 1701. This takes the buyer to the Need Details Window as described in FIG. 16. 1801 is the category selected with the search results, 1802 is the sub category selected, 1803 is the product selected, and the average price populated and start bid price set to average price. The buyer just has to preview and post the need to the market.

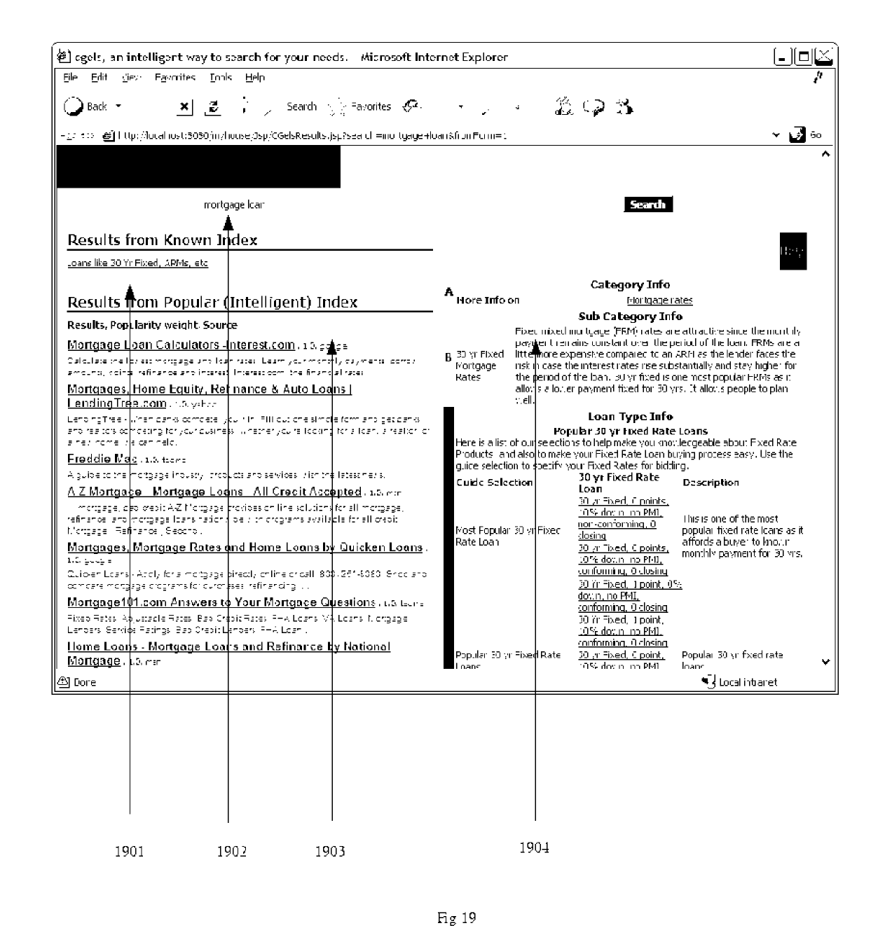

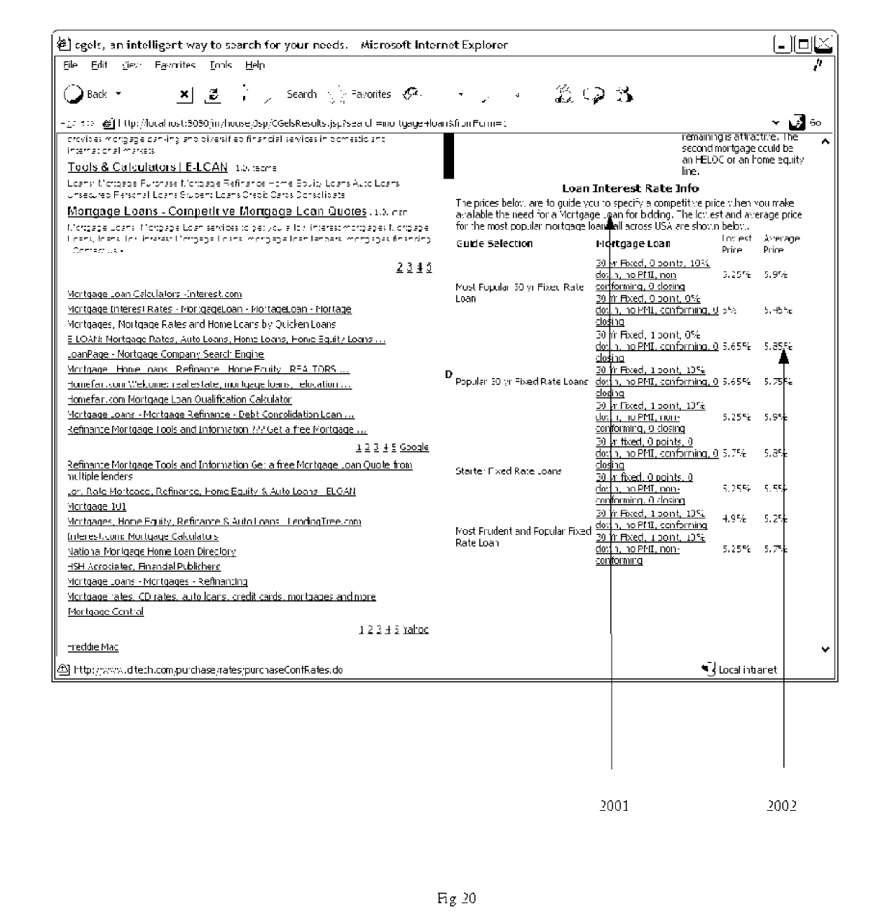

FIG. 19 is an illustration of guiding information providing information to a buyer searching the internet for “mortgage loans” according to a specific embodiment of the present invention. FIG. 19 as described in invention U.S. 60/653,349, “Intelligent Searching With Guiding Info” shows Known Index Results, and Popular (Intelligent) Index Results along with Guiding Information for mortgage loans. 1902 is the “mortgage loan” term entered in the Search Text Box. 1901 is the Known result returned by the search engine. 1903 is the Unknown results returned as the Popular (Intelligent) index. 1904 is the Guiding Information returned for Mortgage loans. FIG. 20 is an illustration of guiding information not visible in FIG. 19. 2001 shows loan information and 2002 shows market competitive information for a region.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

### Definition List 1

| Term | Definition |
|---|---|
| GET | A HTTP method to send/get data from a |
| | server |
| POST | A HTTP method to send/get data from a |
| | server |
| HTTP | A TCP/IP based text request/response |
| | protocol that allows web browsers to show |
| | data from a server called a web server |
| Session | A J2EE HTTP session object, and provides a |
| | way to identify a user across more than one |
| | page request or visit to a Web site and to |
| | store information about that user. |
| J2EE | Java 2 Platform, Enterprise Edition defines |
| | the standard for developing component- |
| | based multitier enterprise applications |
| Jsp | JavaServer Pages technology provides a |
| | simplified, fast way to create dynamic web |
| | content |
| AuctionPostNeedController | A J2EE based server side framework for |
| | building application based on Salmon Open |
| | Source framework. Controller is a server |
| | side object which receives control when the |
| | user clicks on a web page in a browser like |
| | a submit button, etc. |
| Salmon Open Source | An open source MVC J2EE server |
| Framework | framework for building J2EE applications |
| HashMap | A Java collections object |
| DatabaseUtil | A Java object used by ENeedsOnline to |
| | access a datasource |
| SubCategoryHdrs | A Java Object Used by ENeedsOnline to |
| | store sub category specific info like |
| | headers, data types, etc. |
| Datasource | A database like RDBMS or an enterprise |
| | application, etc. |
| SessionManager | A Java object used by ENeedsOnline to |
| | manage user sessions |
| WebSiteUser | A Java object used by ENeedsOnline to |
| | manage user information |
| IM | Instant messaging |
| SMS | Short message service |
| VoIP | Voice over Internet Protocol |
| JDBC | Java Database Connectivity API is a |
| | standard way to access SQL |
| AuctionGetNeedInfoJs.jsp | A jsp page which provides a user interface |
| | to a client browser and passes on control |
| | to a controller object on the server side |
| URL | Uniform Resource Locator |
| XML | Extensible Markup Language |
| TCP | Transmission Control Protocol |
| IP | Internet Protocol |
| Java | An object oriented programming language |
| MVC | Model View Controller paradigm |
| Web | World wide web, www, also known as the |
| | internet |
| Browser | A Graphical User Interface for viewing |
| | content called html on the web |
| ENeedsOnline | An online marketplace where buyers and |
| | sellers can make available a need |

What is claimed is:

1. A method for providing guiding information and credit worthiness to a buyer/seller in a computer based system, the method comprising:
Providing competitive market information such as current market rates, lowest, average and highest prices for a need in a region;
Providing expert information about a need;
Providing credit worthiness information to show the buyer financial strength;
Provide guide selections making it easy for the buyer to become knowledgeable about the market as well as to make an easy selection; said guide selection can be used to make available a need to the market at guide selection price or a reasonable price;
Providing the buyer with a seller process to close the transaction; and provide updates to the buyer on the status of the transaction.

2. A method according to claim 1 wherein said guiding information comprising low, average rates and high rates for a need enable a buyer to place a need to the market; said guiding information available to the seller making a bid on the need; said guiding information available to a plurality of sellers bidding on the need making the market process competitive.

3. A method according to claim 1 wherein said credit worthiness comprising credit rating scores like FICO, estimations of credit rating score like FICO estimations provided by buyer show financial strength to the seller; said credit worthiness used by seller to make a competitive bid on the need; said credit worthiness information available to a plurality of sellers making bids, enabling visibility of the buyer financial strength.

4. A method according to claim 1 wherein said guiding information provides expert information to the buyer of a need making the buyer knowledgeable about the need as well as the market for the need.

5. A method according to claim 1 wherein the buyer uses guide selections provided to select a need and make it available to the market; said guide selection can be used make available the need to the market at guide selection prices or a reasonable price; said guide selections can be used to set the start bid rate.

6. A method according to claim 2, 3 and 5 wherein the buyer makes available a need to the market and a plurality of sellers bid on the need; said buyer sets start bid rate using guide selections and the bid rate gets decremented with every new bid made by a seller.

7. A method according to claim 1 wherein the buyer closes the transaction using a seller defined process; said seller process is web based or application based; said communication occurs in a computer network environment; said seller process, closes transaction and provides updates on close and shipment; said buyer updates transaction status on receiving shipment.

8. A program storage device readable by a machine, tangibly embodying a program of instructions readable by a machine to perform a method for making available a need using guiding information and credit worthiness; said guiding information and credit worthiness available to both buyer and a plurality of sellers who bid on this need; said guiding information provides expert information to the buyer, making the buyer knowledgeable about the market, including prices for the need; said guide selections provide selections to the buyer to make an easy selection of the need and making available the need at a guide selection price or a reasonable price; said credit worthiness presented shows buyer financial strength to a plurality of sellers; said buyer closes transaction using a seller defined process; said seller process provides status updates to the buyer.

9. The program storage device according to claim 8 wherein said guiding information comprising low, average and high rates for a need enable the buyer to place a need to the market; said guiding information available to the seller making a bid on the need; said guiding information available to a plurality of sellers making the market process competitive.

10. The program storage device according to claim 8 wherein said credit worthiness comprising credit rating scores like FICO, estimations of credit rating score like FICO estimations provided by the buyer show financial strength to a seller; said credit worthiness used by the seller to make a competitive bid on the need; said credit worthiness information available to a plurality of sellers making bids, enabling visibility of the buyer financial strength.

11. The program storage device according to claim 8 wherein said guiding information provides expert information to the buyer of a need making the buyer knowledgeable about the need as well as the market for the need.

12. The program storage device according to claim 8 wherein a buyer uses guide selections provided to select a need and make it available to the market; said guide selection can be used to make available the need to the market at guide selection prices; said guide selections can be used to set the start bid rate.

13. The program storage device according to claim 9, 10 and 12 wherein a buyer makes available a need to the market and a plurality of sellers bid on the need; said buyer sets the start bid rate and the bid rate gets decremented with every new bid made by a seller.

14. The program storage device according to claim 8 wherein the buyer closes the transaction using a seller defined process; said seller process is web based or application based; said communication occurs in a computer network environment; said seller process, closes transaction and provides updates on close and shipment; said buyer updates transaction status on receiving shipment.

15. An apparatus for making available a need to the market with guiding information and credit worthiness in a computer based system, the apparatus comprising:
A buyer and a plurality of sellers;
Guiding Information with Guide Selections and Credit Worthiness;
A Competitive Market;
A Seller Process;
Said buyer makes available a need to the, said market using, said guiding information with guide selections and credit worthiness; said guiding information and credit worthiness available to, said plurality of sellers who bid on this need; said guiding information provides expert information to the buyer, making buyer knowledgeable about the market including prices for the need; said guide selections provide market selections to the buyer to make an easy selection of the need and to make available the need at a guide selection price or a reasonable price; said credit worthiness shows buyer financial strength to, said plurality of sellers; said buyer closes transaction using, said seller defined process; said seller process provides status updates to the buyer.

16. The apparatus according to claim 15 wherein said guiding information comprising low, average and high rates for a need enable the buyer to place a need to the market; said guiding information available to the seller making a bid on the need; said guiding information available to a plurality of sellers making the market process competitive.

17. The apparatus according to claim 15 wherein said credit worthiness comprising credit rating scores like FICO, estimations of credit rating score like FICO estimations provided by the buyer show the financial strength to a seller; said credit worthiness used by the seller to make a competitive bid on the need; said credit worthiness information available to a plurality of sellers making bids, enabling visibility of buyer financial strength.

18. The apparatus according to claim 15 wherein said guiding information provides expert information to the buyer of a need making the buyer knowledgeable about the need as well as the market for the need.

19. The apparatus according to claim 15 wherein the buyer uses guide selections provided to select a need and make it available to the market; said guide selection can be used to make available the need to the market at guide selection prices; said guide selections can be used to set the start bid rate.

20. The apparatus according to claim 16, 17 and 19 wherein the buyer makes available a need to the market and a plurality of sellers bid on the need; said buyer sets the start bid rate and the bid rate gets decremented with every new bid made by a seller.

21. An apparatus according to claim 15 wherein the buyer closes the transaction using a seller defined process; said seller process is web based or application based; said communication occurs in a computer network environment; said seller process, closes transaction and provides updates on close and shipment; said buyer updates transaction status on receiving shipment.
